(19) United States
(12) Patent Application Publication
(10) Pub. No.: US 2025/0043625 A1
(43) Pub. Date: Feb. 6, 2025

(54) TRANSLATIONAL ROLLER SHADE SYSTEM

(71) Applicant: Melvin N. Bakalar, West Bloomfield, MI (US)

(72) Inventor: Melvin N. Bakalar, West Bloomfield, MI (US)

(21) Appl. No.: 18/791,400

(22) Filed: Jul. 31, 2024

Related U.S. Application Data
(60) Provisional application No. 63/529,987, filed on Jul. 31, 2023.

(51) Int. Cl. E06B 9/42; E06B 9/40

(52) U.S. Cl. CPC E06B 9/42; E06B 2009/402; E06B 2009/405

(57) ABSTRACT

A translatable roller shade system having: elongated first and second tracks positioned in parallel adjacent each other with the tracks each having a channel with a downward-facing slot extending along the track between the first and second ends of the roller shade system; and first and second roller shades each having a tube, a shade wrapped on the tube, first and second roller brackets that support the tube at each end of the tube, and a length adjuster that connects between the tube and at least one roller bracket to enable adjustment of the roller shade between a lowered and raised positions. The first and second roller shades are supported from above by the respective first and second tracks for translational movement relative to the tracks and each other such that the roller shades can be moved left or right along the tracks between fully overlapped and minimally overlapped positions.

### TECHNICAL FIELD

The present invention relates to roller shades for glazed exterior building openings.

### BACKGROUND

Roller shades are typically single shades mounted on a tube that is fixed above a window or other glazed opening using journaled bearing mounts that permit the shade to be rolled and unrolled from the tube to thereby selectively cover the opening. Apart from the ability to raise or lower the shade, systems have been proposed that utilize alternating sections of opaque and partially transparent material on two shades that can be selectively moved into partial or complete overlapped positions to thereby control the amount of light through the combined shades. See, for example, U.S. Pat. No. 8,025,088 which discloses roller shades with vertical alternating sections and limited relative lateral movement to control light transmission through the combined shades, and US 2006/0027339A1 which discloses non-translational, fully overlapping roller shades having horizontal sections such that the shades can be raised or lowered in varying amounts to control the overall light transmission through the combined shades. These roller shade systems require alternating opaque and partially transparent sections of the shade which limits the aesthetics of the shade as they prevent the use of what typically is a more desirable uniform appearance of the shade across its surface.

Window coverings other than roller shades are also known, including some that have translational movement of the coverings relative to each other. See, for example, U.S. Pat. No. 6,860,064 which discloses two fixed-height panels (not roller shades) and a track system that allows the panels to be aligned in a coplanar manner side-to-side or moved relative to one another into an overlapping, parallel alignment using transfer tracks that permits either or both shades to be moved between two parallel tracks. See also, US 2011/0219692A1 which discloses shutter blinds mounted on parallel tracks for lateral movement relative to each other.

With these and other prior art shade systems, there still remains a need for a window covering arrangement that provides maximum flexibility in window/glass door coverings by enabling any permutation of the two shades together in terms of shades being raised or lowered and moved left or right in fully overlapping and non-overlapping configurations.

### SUMMARY

In accordance with one aspect of the invention there is provided a translatable roller shade system for mounting over a building opening, the roller shade system comprising:
elongated first and second tracks that, when mounted, are positioned adjacent each other such that they extend horizontally in parallel from a first end of the roller shade system to a second end of the roller shade system, the tracks each having a channel that, when mounted, has a downward-facing slot extending along at least a substantial portion of the track between the first and second ends of the roller shade system; and
first and second roller shades each comprising a tube, a shade wrapped on the tube, first and second roller brackets that support the tube at each end of the tube, and a length adjuster that connects between the tube and at least one roller bracket to enable adjustment of the roller shade between a lowered position in which the shade is lowered over the building opening and a raised position in which the shade is rolled up onto the tube so as to reveal the building opening;
wherein the first and second roller shades, when installed, are supported from above by the respective first and second tracks for translational movement relative to the tracks and each other such that the roller shades can be moved left or right along the tracks between fully overlapped and minimally overlapped positions.

In accordance with another aspect of the invention there is provided a roller shade system comprising: a pair of roller shades each having a shade that can be retracted and extended between fully raised and fully lowered positions, wherein the roller shades can be independently translated left and right into fully overlapped and minimally overlapped positions relative to each other independently of the lengthwise extension or retraction of the shades, wherein the pair of roller shades can be arranged into 16 different configurations of the fully overlapped, minimally overlapped, fully raised, and fully lowered positions.

### BRIEF DESCRIPTION OF THE DRAWINGS

One or more illustrative embodiments will hereinafter be described in conjunction with the following figures, wherein like numerals denote like elements, and wherein:

FIG. 1 depicts a room of a building having a vertical wall containing a glazed opening, such as a sliding glass door, to depict an example environment in which the roller shade system of the invention may be used;

FIG. 2 is a horizontal cross-sectional view of the vertical wall and glazed opening of FIG. 1;

FIG. 3 is a perspective view of an embodiment of a translational roller shade system of the invention that has first and second roller shades;

FIGS. 4A and 4B are vertical cross-sectional view of the vertical wall and glazed opening of FIG. 1 showing the roller shade system of FIG. 3 with the first and second roller shades having different relative shade length adjustments;

FIG. 5 is an exploded view of the first roller shade;

FIG. 6 is a cross section view of the roller shade system taken along the 6-6 line of FIG. 3;

FIG. 7 is an enlarged, fragmentary view of the track assembly and upper portion of the roller brackets from FIG. 6;

FIGS. 8A and 8B show example embodiments of the roller brackets used in the roller shade system;

FIGS. 9A and 9B show the alignment of one of the roller tube assemblies and roller brackets with a corresponding track for purposes of assembly of the first roller shade;

FIG. 10A shows one example of a tube assembly of the first roller shade;

FIG. 10B shows a spring-assist type shade length adjuster that may be used in an alternative embodiment of the first and/or second roller shades;

FIG. 11A is a top view of one of the two identical tracks;

FIG. 11B is a top perspective fragmentary view of the track of FIG. 11A;

FIG. 12A shows the track assembly components in a disassembled state;

FIG. 12B shows a portion of the track assembly with the components in an assembled state;

FIGS. 13A and 14A show an end bracket and center bracket, respectively, attached to the tracks in the orientation used when mounting the roller shade system;

FIGS. 13B and 14B respectively show the end bracket and center bracket of FIGS. 13A and 14A, respective, alone in an upside down orientation to show detail of T-nuts that are integrally formed into connecting brackets of the track assembly;

FIG. 15 is a table listing the 16 permutations of possible roller shade configurations that utilize fully overlapped, minimally overlapped, fully raised, and fully lowered positions of the two roller shades; and

FIG. 16 is an enlarged, fragmentary view as in FIG. 7 showing an alternative embodiment of the roller brackets.

### DETAILED DESCRIPTION

The embodiments of the translational roller shade system described herein are assemblies of a number of components and subassemblies. They are primarily described as they would be arranged and interconnected when the roller shade system has been mounted or installed for use. However, these roller shade systems are typically shipped and sold partially disassembled. It is for this reason that at least some of the appended claims directed to the roller shade system have been written to define the components and subassemblies of the invention and identify their interconnections and interrelationships as they would exist when the roller shade system is mounted or installed for use. Thus, as used herein, the phrases “when mounted” and “when installed” refer to the configuration of the roller shade system and its components when the roller shade system is mounted in a functional orientation over a building opening, such as over glazed openings like windows and sliding or hinged glass doors.

Except when expressly stated or otherwise inherently required by context, directional terms such as upwardly, downwardly, upper, lower, above, below, left, right, and the like all refer to the orientation of a component or assembly when the roller shade system is mounted in its functional orientation above a building opening. FIG. 3 includes an identification of directions for depth (D), length (L), and width (W) that are used herein.

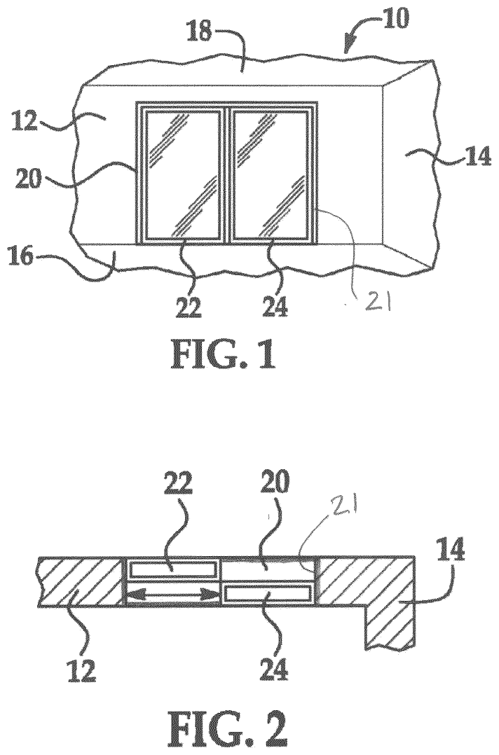

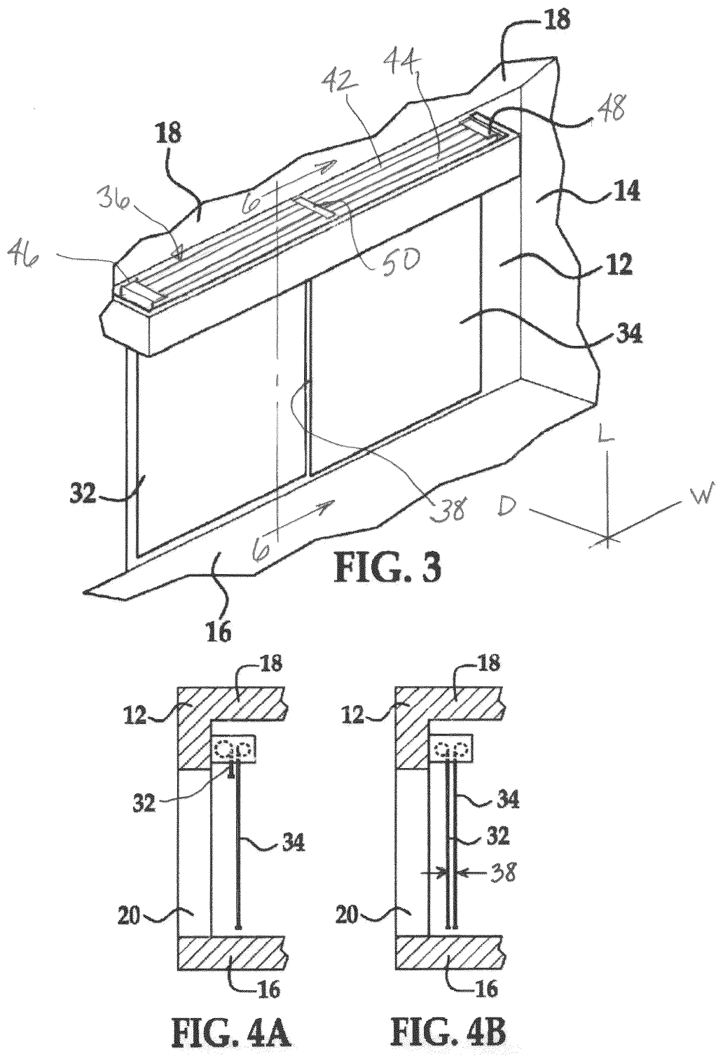

FIGS. 1 and 2 are included for the purposes of describing the environment of the invention. FIG. 1 depicts a room 10 of a building such as a house or other structure meant for human occupancy, the room including vertically extending walls 12 and 14, and a floor 16 vertically separated from a ceiling 18. The wall 12 includes a rectangular shaped building opening 20 that may be an interior or exterior opening of the building. The opening is a glazed opening, such as one having a sliding glass door system comprising a frame 21, a fixed glass panel 22, and a sliding glass panel 24. As the description proceeds, it will become apparent how the invention can be applied to other building openings, such as windows, adjacent fixed panels, as well as other glass doors and windows having three or more adjacent glazed panels.

FIG. 2 shows a horizontal cross-sectional view of vertical wall 12 defining the building opening 20 and showing the door frame 21 which includes conventional track members for supporting the framed glass panels 22 and 24 on separate adjacent tracks. As shown in FIG. 2, the glass panel 24 is capable of sliding in the direction shown by the arrow between open and closed positions, while glass panel 22 is generally stationary in a fixed position. The building opening and sliding glass door system can be conventional as is well known in the art and will not be described to any significant degree.

FIG. 3 shows a perspective view of an embodiment 30 of the invention in the form of a translational roller shade system having a first roller shade 32, and second roller shade 34, and a track assembly 36 which, as shown, may be covered by an optional decorative valence. The roller shades 32, 34 are themselves assemblies of multiple parts that enable adjustment of the roller shade between a lowered position in which the shade substantially obscures the building opening 20 and a raised position in which the shade is rolled up so as to reveal the building opening. Each roller shade 32, 34 is suspended below, and supported by, a separate respective track 42, 44 of the track assembly 36. The elongated tracks 42, 44 are positioned adjacent each other such that they extend horizontally in parallel from a first end of the roller shade system to a second end of the roller shade system. As will be described farther below, the tracks 42, 44 each have a channel that, when mounted, has a downward-facing slot extending along at least a substantial portion of the track between the first and second ends of the roller shade system. The roller shades, when installed, are supported from above by their associated tracks for translational movement relative to the tracks and each other such that the roller shades can be moved left or right along the tracks between fully overlapped and minimally overlapped positions. As used herein, the term “fully overlapped” means that the roller shades, when mounted, are both fully moved either to their left-most extreme position or to their right-most extreme position, even though they may not be completely aligned or overlapping.

Although FIG. 3 is a somewhat diagrammatic illustration of the roller shade system 30 and its installed environment, it will be appreciated that the size of the shades, specifically their width and length, can be selected such that they provide complete coverage of the glazed portion of the building opening 20 when the roller shades 32, 34 are unrolled to their fully lowered positions and moved apart to their minimally overlapped position. Thus, full blocking of the view through the glazed opening may be obtained by installing roller shades 32, 34 that each have a width and fully lowered length that are the same or larger than the width and length of the glazed panels, respectively.

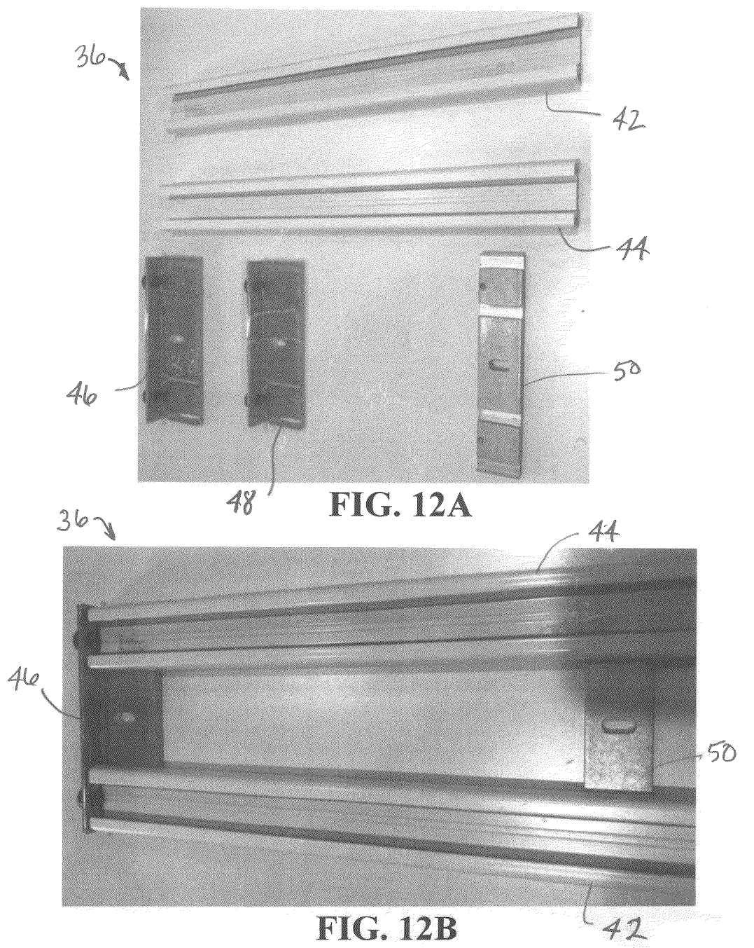

The roller shade system 30 includes, as a part of the track assembly 36, a plurality of connecting brackets 46, 48, 50 that each attach to both tracks 42, 44 to rigidly fix the tracks together into a spaced, parallel orientation relative to each other. These brackets include a pair of end brackets 46, 48 and a center bracket 50. The individual tracks and connecting brackets are shown in their disassembled state in FIG. 12A, as will be discussed farther below. The end brackets 46, 48 can be identical parts with a symmetry that permits them to be rotated 180 degrees for use at the opposite first and second ends of the roller shade system. Thus, end bracket 46 is located at the first end of the roller shade system 30 and end bracket 48 is located at the second end of the roller shade system with each track extending from a first end attached to bracket 46 to a second end attached to bracket 48.

Since each track runs the full width of the roller shade system 30, each roller shade 32, 34 can be translated along its associate track between a fully left position and a fully right position, independently of the other roller shade. This, coupled with the ability to independently raise or lower each roller shade means that the roller shade system can be arranged into various configurations that maximize the flexibility of the system to block or admit light and visual viewing through the glazed building opening.

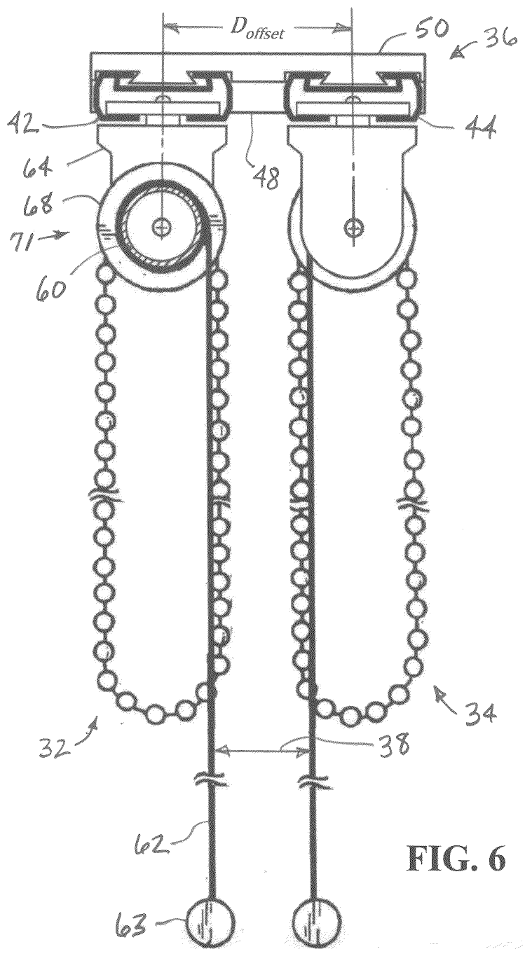

FIGS. 4A and 4B depict example shade length adjustments, with FIG. 4A showing roller shade 32 being rolled into its raised position (which may be a fully raised position) and roller shade 34 being unrolled into its lowered position (which may be a fully lowered position). Each roller shade 32, 34 additionally permits arbitrary, stationary positioning of the shade at any of a number of positions between the fully raised and fully lowered positions This can be done using a conventional length adjuster, whether clutch-type, spring assist, motorized, or other. FIG. 4B shows both roller shades in their fully lowered position with a fore-and-aft gap 38 between the shades (i.e., in the depth direction D). As will be apparent from FIG. 4B and will be discussed further in connection with FIG. 6, the two rollers shades 32, 34 are mounted to the track assembly 36 such that they have opposite directions of rotation when unrolling (and when rolling up), and such that they roll and unroll from the side of each roller nearest the other roller so that, when in the configuration shown in FIG. 3, the gap 38 will minimize the amount of view through the building opening that is visible between the adjacent edges of the shades.

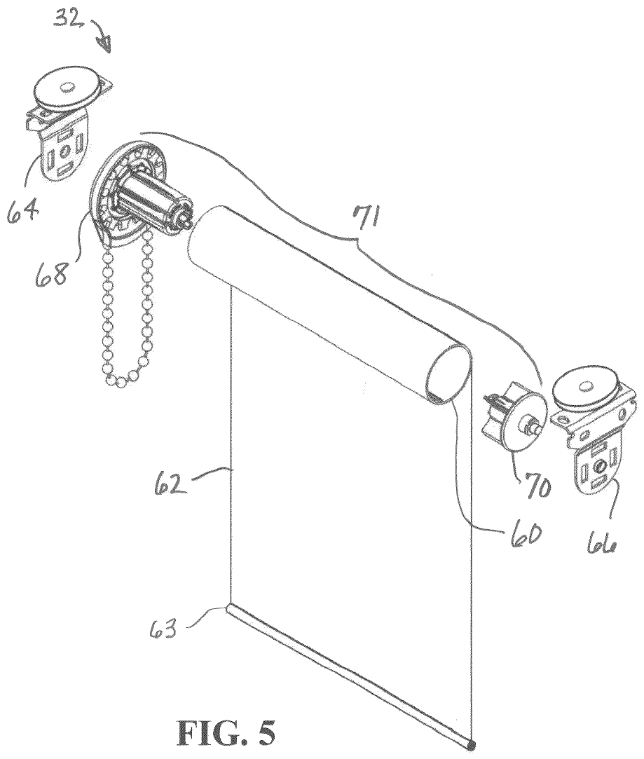

FIG. 5 shows an exploded view of the roller shade 32, it being understood that roller shade 34 is, but need not be, identical to roller shade 32. Roller shade 32 primarily includes: a tube 60 such as made from extruded aluminum or otherwise; a shade 62 wrapped on the tube 60; first and second roller brackets 64, 66 that support the tube 60 at each end of the tube; and a clutch-type length adjuster 68 that connects between the tube and at least one roller bracket. The length adjuster 68 permits user adjustment of the roller shade 32 between a lowered position in which the shade 62 is lowered over the building opening 20 and a raised position in which the shade 62 is rolled up onto the tube 60 so as to reveal the building opening. Shade 62 may be made from any suitable material that can roll and unroll from the tube 60. The shade 62 may be partially transparent, translucent, or opaque such as room darkening shades, and may include a repeating or non-repeating pattern, and the like, whether by printing on the shade material or as woven in or otherwise. In at least some embodiments, shade 62 of each roller shade 32, 34 has a substantially uniform appearance throughout the length and width of the shade, meaning that the shade does not include substantial areas of different transparency or opaqueness, but rather has a uniform or substantially uniform transparency or opaqueness across the surface of the shade. The shade 62 may include a bottom rail 63, which can provide shade material tensioning weight and aids the user in grasping the shade when raising or lowering.

In the illustrated embodiment, the length adjuster 68 connects between the tube 60 and a single roller bracket, i.e., roller bracket 64. To support the other end of the tube 60 for rotation, the roller shade 32 includes a idler end cap 70 that connects between the tube 60 and roller bracket 66. The tube 60, shade 62, length adjuster 68, and end cap 70 together comprise a tube assembly 71 which is mounted to and supported by the roller brackets 64, 66 for shade rolling and unrolling rotation relative to the roller brackets.

The length adjuster 68 can be constructed in any of a number of ways known to those skilled in the art, and is used to permit adjustment of the roller shade to a desired length between the fully lowered position and the fully raised position. As indicated in FIG. 5, the length adjuster 68 can be a standard chain driven clutch type that provides for manual rotation of the tube 60 to raise or lower the shade 62. In other embodiments, a so-called “zero gravity” mechanism may be used. As is known to those skilled in the art, these zero gravity roller shades allow for cordless (chainless) operation using a spring-assist length adjuster that includes a coil spring which winds or unwinds from its relaxed state as the shade 62 is manually unrolled by pulling on the bottom of the shade. The potential energy stored in the spring during this unrolling is then used when the shade 62 is being rolled up such that the user need not use much force to raise the shade. Other types of manual or motorized length adjusters for rotating the tube 60 in both clockwise and counter-clockwise directions may be used in lieu of that illustrated here.

FIG. 6 depicts a cross sectional view of the roller shade system 30 of FIG. 3 without the valence, building walls, or other portions of the environment that are shown in FIG. 3. At the top of the system 30 is the track assembly 36 which includes, from this cross-sectional view, the right end connecting bracket 48, the center connecting bracket 50, and the two tracks 42, 44 mounting to the connecting brackets. The roller shades 32, 34 are supported from above by their roller brackets 64, 66 (only 64 shown in FIG. 6), which are attached to the tracks 42, 44 in a manner that allows the roller brackets, and thus the complete roller shades 32, 34 themselves to move along the tracks and relative to each other such that the roller shades can be independently moved left or right along the tracks between fully overlapped and minimally overlapped positions.

As mentioned above in connection with FIG. 4B, the roller shades 32, 34 are mounted such that they (1) use oppositely-directed rotation to raise or lower the shade 62 and (2) roll and unroll from the side of the roller shade closest to the other roller shade. In particular, from the left side sectional view shown in FIG. 6, the roller shade 32 uses a clockwise rotation to lower the shade 62, whereas the roller shade 34 uses a counter-clockwise rotation to lower the shade. And, both shades roll and unroll in the space between the two roller shades. This inside reverse roll direction helps minimize the gap 38 between the planes of the shades 62 so as to help maximize the privacy afforded by the roller shade system 38 when the shades are lowered and positioned at opposite left/right ends of the track assembly. Thus, as used herein, “inside reverse roll direction” means that the roller shades have opposite rotational directions such that, when mounted, the shade of each roller shade rolls and unrolls from a side of the roller shade closest to the other roller shade.

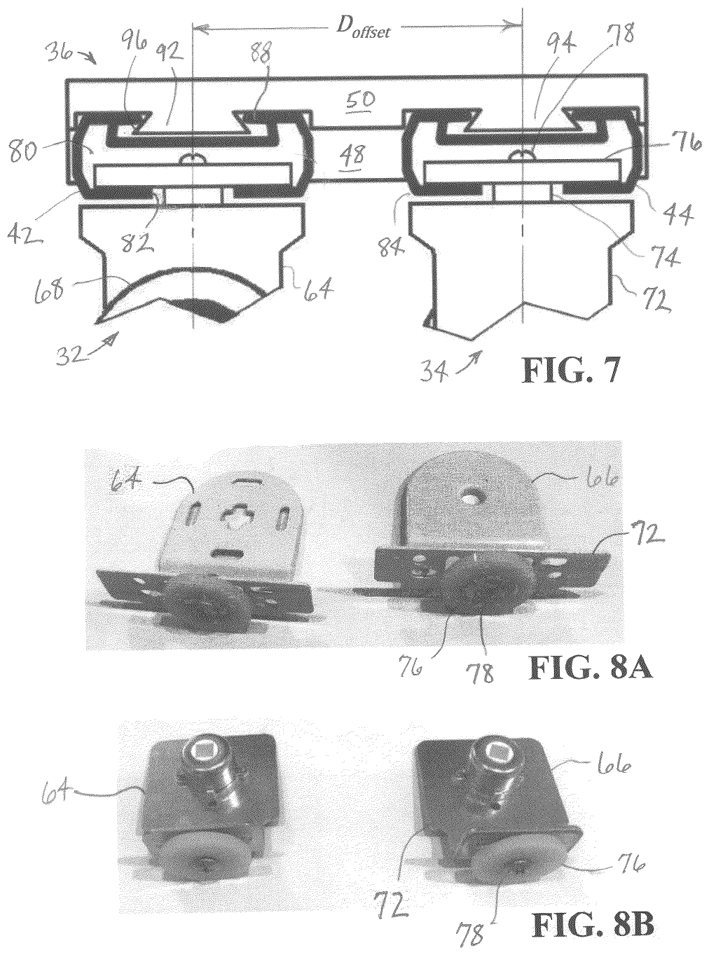

FIG. 7 depicts an enlarged, fragmentary view of the track assembly 36 and the upper portion of the roller brackets 64 from FIG. 6. As shown, the roller shades 32, 34 are supported by their associated respective tracks 42, 44 via the roller brackets 64 (and 66, not visible in the cross-section). With reference also to FIGS. 5, 8A, and 8B, the roller brackets 64, 66 each include a bracket body 72, a low-friction elastomeric spacer 74, a glide member 76, and a fastener 78 that attaches the glide member and spacer to the bracket body. An alternative embodiment of the roller brackets is shown at 164, 166 of FIG. 16. In this embodiment, the each bracket 164, 166 includes the bracket body 72, elastomeric spacer 74, glide member 76, and fastener 78, but further includes a second low-friction glide member 176 positioned between the spacer 74 and bracket body 72. In this embodiment, the thickness of spacer 74 may be selected to be just slightly larger than the thickness of the tracks 42, 44 so that the roller brackets 164, 166 have a tighter fit to the respective tracks 42, 44 to thereby reduce the “play” (vertical movement) of the brackets as the roller shades are translated along the tracks. By utilizing the second glide member 176 below the track, this tighter tolerance fit of the roller brackets onto the tracks can be achieved without any significant increase in resistance of the roller shades to moving along the tracks, and this is because the low-friction glide member 176 minimizes friction and noise when engaging the bottom of the track during movement of the roller shades along the track. The roller brackets 64, 66 (and roller brackets 164, 166) can be identical or different, depending upon various considerations, such as the need for different connecting features between the brackets and the two ends of the tube assembly 71. For example, the roller bracket set shown in FIG. 8A have similar, but not identical roller brackets whereas the set shown in FIG. 8B has identical roller brackets.

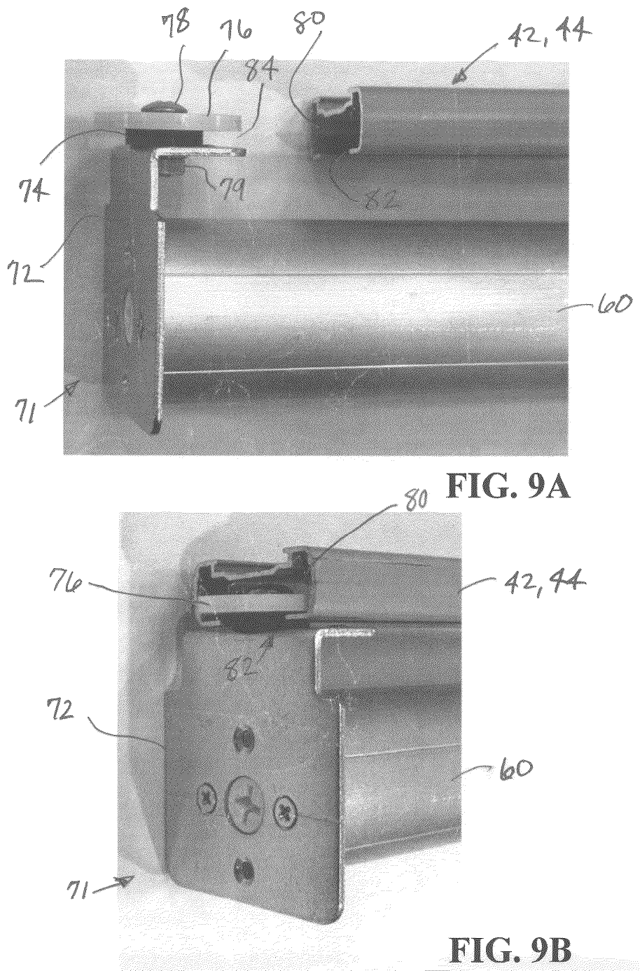

FIG. 9A depicts one end of the tube assembly 71 with a bracket 64 connected to the tube 60 and with its glide member 76 just prior to insertion into one of the tracks 42, 44. FIG. 9B depicts the tube assembly 71 with the glide member 76 positioned in the end opening of one of the tracks 42, 44

As shown in FIGS. 7, 9A, and 9B, the glide members 76 each fit into a channel 80 of one of the tracks 42, 44 from an end of the track. The glide member 76 of each roller bracket 64, 66 is attached to the bracket body 72 via the fastener 78 that extends from the glide member 76, through a slot 82 in channel 80, to the bracket body 72. The glide member 76 is larger than the slot 82 such that the glide member is captured for gliding movement along the track inside the channel 80 to thereby permit translational movement of the roller shades along the length of the track. The spacer 74 fits around the fastener 78 between the glide member 76 and bracket body 72 to provide a space 84 between the glide member 76 and bracket body 72 that is larger than the thickness of the portion of the tracks 42, 44 that define the slot 82. This provides clearance that allows the roller shades 32, 34 to move easily along the tracks 42, 44 between their first and second ends.

The fastener 78 acts as a connecting link of reduced diameter that secures the glide member 76 to the bracket body 72. As shown in FIG. 9A, the fastener 78 comprises a bolt having a nut 79 threaded onto the end of the bolt opposite the head of the bolt. Other types of connecting links may be used, including rivets and other types of fasteners, adhesives, and the like.

Glide member 76 may take any suitable form and preferably is made from a low friction, high resilience material such as nylon or acetal plastic (Delrin). The glide member 76 shown in the figures is securely fastened against the spacer 74 and need not be in the form of a washer as shown; rather it can be a rectangular or other polygonal shape. In other embodiments glide member 76 may be rotationally attached to the connecting link 78.

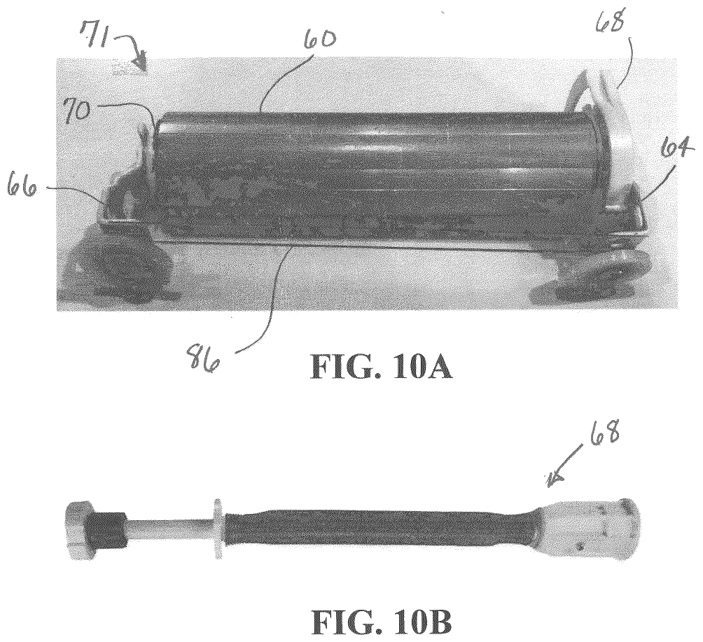

FIG. 10A depicts a prototype tube assembly 71 including a short tube 60, roller brackets 64, 66, and a clutch-type length adjuster 68. In some embodiments, the tube assembly can include an aluminum or other rigid bar 84 extending between the roller brackets 64, 66. The bar 84 may have through holes adjacent its opposite ends so as to be secured to each bracket body 72 using the connecting link/fastener 78 or using a separate fastener. This bar 86 works to retain the brackets 64, 66 in fixed engagement with the length adjuster 68 and end cap 70 to prevent unintentional separation of these components. In lieu of including the bar 86, the end brackets 64, 66 can be securely fastened to tube assembly 71; e.g., to the length adjuster 68 and end cap 70, which themselves can be securely fastened to tube 60, to maintain these parts securely together over the service lifetime of the roller shade system 30. Various secure ways of attaching the roller brackets to the tube assembly 71 will be apparent to those skilled in the art, such as adhesive, interference fit (e.g., press-fit), snap rings, or some positive mechanical interlock of the mating elements. In such an embodiment, bar 86 is not needed to maintain the two roller brackets in engagement with the tube assembly 71.

FIG. 10B depicts an alternative, spring-assist type shade length adjuster which may be used for in a cordless/chainless zero-gravity roller shade system. As with the embodiments shown in FIGS. 5 and 10A, the spring-assist length adjuster 68 fits within and attaches to one end of the tube 60 with an end cap 70 provided at the opposite tube end.

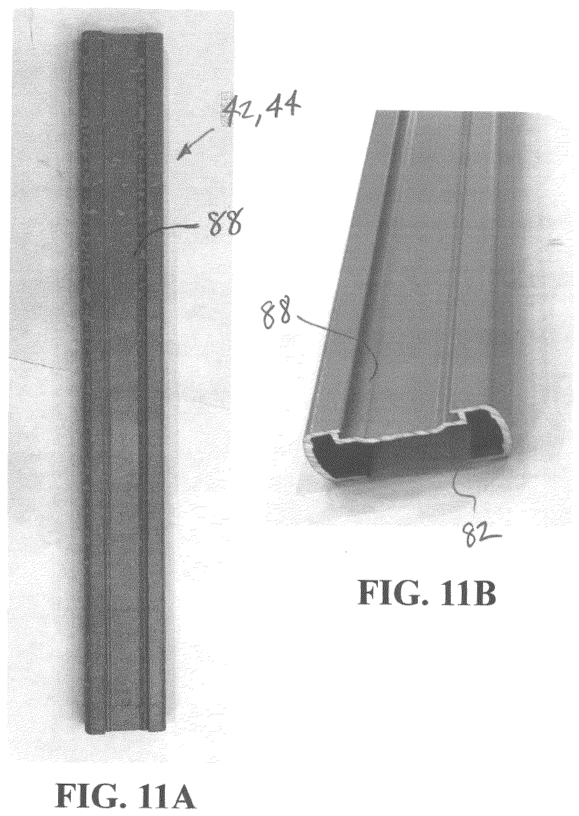

FIG. 11A is a top view of one of the identical tracks 42, 44. FIG. 11B is a top perspective fragmentary view of that same track 42, 44 showing one of two identical ends of the track. For purposes of mounting the tracks 42, 44 to the connecting brackets 46, 48, 50, the upper side of the track (opposite the slot 82) includes an external T-slot rail 88 extending between the first and second ends of the track and formed as an integral part of the track. As shown in FIG. 7 and discussed farther below, each end bracket includes a pair of T-nuts 92, 94 that fit into mating engagement with the T-slot rail 88 at an end of each respective track 42, 44. The center bracket 50 also includes a pair of the integral T-nuts 90, 92 on a lower side of the center bracket that are adapted to fit into mating engagement with the T-slot rails 88. In this way, the T-nuts 92, 94 of the connecting brackets 46, 48, 50 hold the tracks 42, 44, respectively, in a spaced, parallel orientation.

FIG. 12A depicts the track assembly 36 components in a disassembled state and upside down relative to their orientation when mounted. This includes tracks 42, 44, end brackets 46, 48, and center bracket 50. Tracks 42, 44 can be identical, but need not be. Similarly, end brackets 46, 48 can be identical, but need not be. For shorter width roller shade systems, no center bracket may be needed. Conversely, for longer width roller shade systems, two or more center brackets may be needed.

FIG. 12B shows a portion of the track assembly 36 in an assembled state, with tracks 42, 44 being connected to end bracket 46 and center bracket 50.

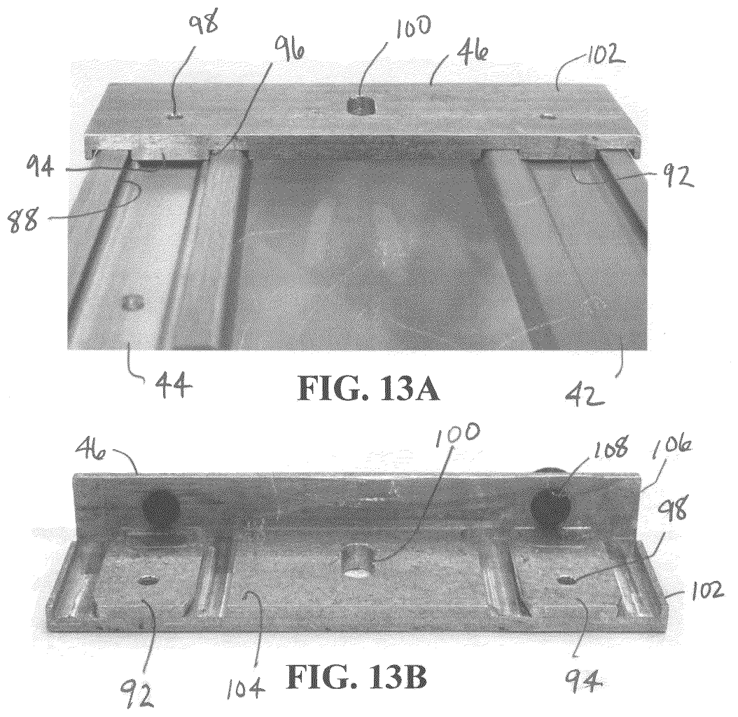

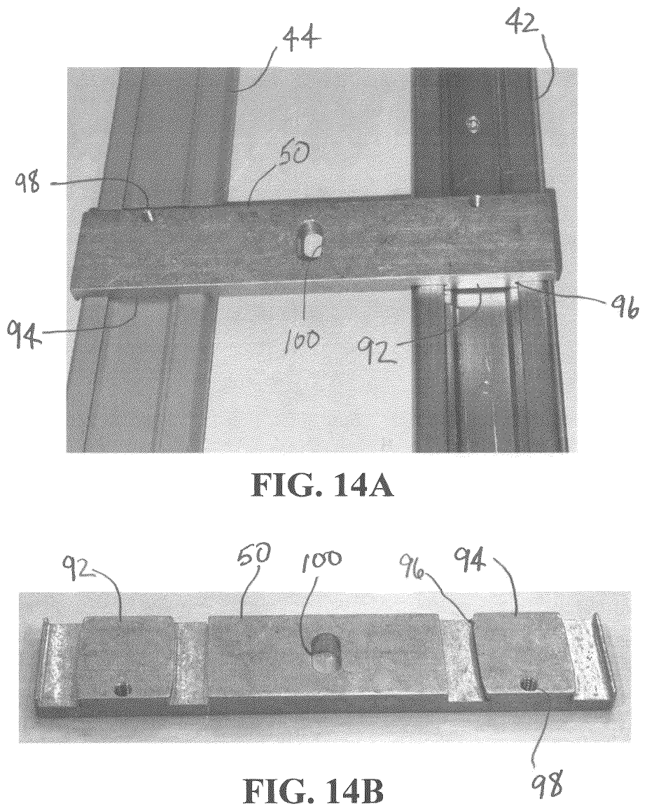

FIGS. 13A and 14A show the end bracket 46 and center bracket 50, respectively, attached to tracks 42, 44 in the orientation used when mounting. FIGS. 13B and 14B respectively show the end bracket 46 and center bracket 50 alone in an upside down orientation to show detail of the T-nuts 92, 94 that are integrally formed into the connecting brackets. As can be seen in these figures, as well as FIG. 7, the integral T-nuts 92, 94 are formed with undercuts 96 on each side of the nut to mate with the portions of the tracks 42, 44 that define the T-slot rail 88. As a result, when the T-nuts are slid into the T-slot rails 88 from an end of the tracks, the tracks are captured by the engagement of the T-slot rail edges in the undercuts 96, thereby keeping the tracks tightly suspended by the connecting brackets. The connecting brackets can include a threaded bore 98 located through each T-nut 92, 94 to allow friction locking of the tracks 42, 44 to the connecting brackets 46, 48, 50 using a set screw to maintain a rigid, non-moving connection between the tracks and connecting brackets.

The connecting brackets 46, 48, 50 have center slots 100 that can be used for mounting of the roller shade system 30. Mounting of the shade system to a downward facing overhead wall surface, such as inside the building opening, can be done using fasteners such as screws inserted through the slots 100 and fastened into the overhead surface. For vertical wall mounting, a standard angle bracket may be bolted to the top of the connecting brackets using the center slots 100 and then to the vertical wall. These center slots may also be used to attach a valence bracket.

The end brackets 46, 48 each include an upper plate 102 having the T-nuts 90, 92 located on a lower side 104 of the upper plate and a side plate 106 extending downwardly from the upper plate adjacent the T-nuts. The side plate 106 forms an abutment against which one end of each of the tracks bear when the end bracket is attached to that end of the tracks by having the T-nuts fully inserted into the T-slots at that one end. For preventing noise between these components, the side plate 106 may include a pair of elastomeric bumpers 108 against which the ends of the tracks may rest once assembled.

The tracks 42, 44 and connecting brackets 46, 48, 50 may be made of any of a number of different suitable materials and using various manufacturing techniques that will be known to those skilled in the art. In the illustrated embodiment, the connecting brackets 46, 48, 50 each comprise a unitary piece of milled aluminum, and each of the tracks comprise identical sections of extruded aluminum that have a uniform cross-section along their length.

The tracks 42, 44 are spaced from each other in the depth direction D which results in the gap 38 between the shades 62. The size of the gap 38 must be at least large enough that the two roller shades 32, 34 can be translated in their individual tracks past each other without interfering contact. For the illustrated embodiments, the track spacing is fixed due to the fixed spacing of the T-nuts on the connecting brackets to which the tracks are mounted. In other embodiments the tracks may be attached to the connecting brackets using slots or other connecting features that permit adjustment of the track spacing. For example, the T-nuts 92, 94 may be implemented as separate components adjustable in the depth direction.

The gap 38 permits at least a small amount of light and viewing between the shades when moved apart to their minimally overlapped position. As used herein, the “minimally overlapped” position of the roller shades means that they are located at opposite left/right ends of the roller shade system 30, leaving them either fully non-overlapping or having a small width-wise overlap of not more than 6 inches. In some embodiments, the minimally overlapped position results in a small overlap that is within a range of 1 to 6 inches, preferably within a range of 2 to 4 inches, and most preferably within a range of 2.5 to 3.5 inches. This small overlap helps minimize view through the gap 38 for privacy.

In embodiments wherein the track spacing in the depth direction can be adjusted at installation—e.g., by using connecting brackets having T-nuts (or other track retaining connections) that are adjustable in the depth direction—this small overlap can be set as desired at installation. Where the fore-aft spacing of the roller shades is fixed (e.g., no depth-direction adjustability of the tracks or of the roller brackets relative to the tracks), then the size of this small overlap can be designed in by, for example, predetermination of the spacing between the tracks which, in the illustrated embodiment, is set by the spacing of the integral T-nuts 92, 94 on the connecting brackets.

In the fixed track spacing approach of the roller shade system 30, this small overlap preferably has a minimum overlap distance (Dₒᵥₑᵣₗₐₚ) that is large enough to obscure viewing through the gap at angles at and above a minimum gap angle (A_{gap}) measured relative to the plane of the shade using a hypotenuse connecting the adjacent (nearest) edges of the shades 62 when the roller shades 32, 34 are in their minimally overlapped (fully left/right) position shown in FIG. 3. The minimum gap angle A_{gap} of obscured view may be different for different applications of the roller shade system. For commercial use, whether for exterior or interior (e.g., conference room) privacy or light blocking, a larger minimum gap angle A_{gap} may be used, such as being fully non-overlapping (90 degrees or greater) or with a smaller overlap of no more than 3 inches. In residential use, greater privacy may be desired in which case a smaller minimum gap angle A_{gap} may be used, such as 45 degrees or less or, depending on the size of gap 38, by providing a larger overlap of at least 2 inches.

As an example, and with reference back to FIGS. 6 and 7, for sliding glass doors used in standard building openings of 6′6″, 6′8″, and 8′0″, a 1.5 inch diameter tube 60 would typically be used with a maximum shade length of about 96 inches (8′0″). For these dimensions, an offset distance (D_{offset}) of 3 to 5 inches between the tube assemblies 71 provides sufficient spacing of the roller shades 32, 34 to allow non-interfering clearance for all of the components on the tube assemblies 71 when the roller shades are translated past one another. In a preferred embodiment, this offset distance is in the range of 3 to 4 inches and most preferably 3.5 inches, or within 10% of 3.5 inches. This offset distance D_{offset} can be simply implemented by suitable spacing of the T-nuts 92, 94 on each of the connecting brackets.

For the roller shade system 30 set up with the inside reverse roll direction of the roller shades 32, 34, the actual depth direction spacing between the shades 62 is a function of the vertical length at which each shade is set at any one time. For example, with the shades 62 rolled up onto their respective tubes 60 to their fully raised positions, the material thickness of the shades will bring them closer together in the depth direction, and when in their fully lowered position, the mostly unwound shades will be farther apart in that same direction. Thus, references herein to the size of the gap 38, are to the magnitude of the gap measured in the depth direction D when the shades 62 are in their fully lowered position, as is shown in the FIGS. 3 and 6. If the shades are equipped with bottom rails, then for purposes of determining the size of the gap 38, the magnitude of the gap is to be measured in the absence of any interference of contact between those bottom rails.

Thus, for an inside reverse roll direction of the two roller shades 32, 34, the size of gap 38 (as is measured with the shades extended to their fully lowered position), will be equal to the offset distance D_{offset} minus the two radii of the tubes 60 and minus the two thicknesses of any remaining shade material on the tubes. This is evident from FIG. 6. Taking the remaining shade material thickness as negligible, and assuming equal tube diameters, calculation of the size of gap 38 can be simplified to the offset distance minus tube diameter (2×tube radius). Thus, where the roller shades 32, 34 have a 3.5 inch offset distance and the tubes a 1.5 inch diameter, the gap size will be 2 inches. From this, the minimum overlap distance (Dₒᵥₑᵣₗₐₚ) of the two shades needed to achieve any particular gap angle A_{gap} can be calculated as:

$${D}_{overlap} = \frac{2}{tan {A}_{gap}} .$$

Thus, for the 2 inch gap and a desired gap angle of 60 degrees, the minimum overlap Dₒᵥₑᵣₗₐₚ of the shades will be 1.2 inches (rounded up). Generally, gap angles in the range of 20 to 75 degrees provide both a reasonable amount of overlap and reasonable privacy/light blocking. In some embodiments, the gap angle can be in the range of 25 to 50, preferably 30 to 40 degrees, and most preferably 30 to 35 degrees. For the 2 inch gap and equation provided above, a 3 inch overlap provides obscuration of view through the gap at gap angles greater than 33.7 degrees (rounded up).

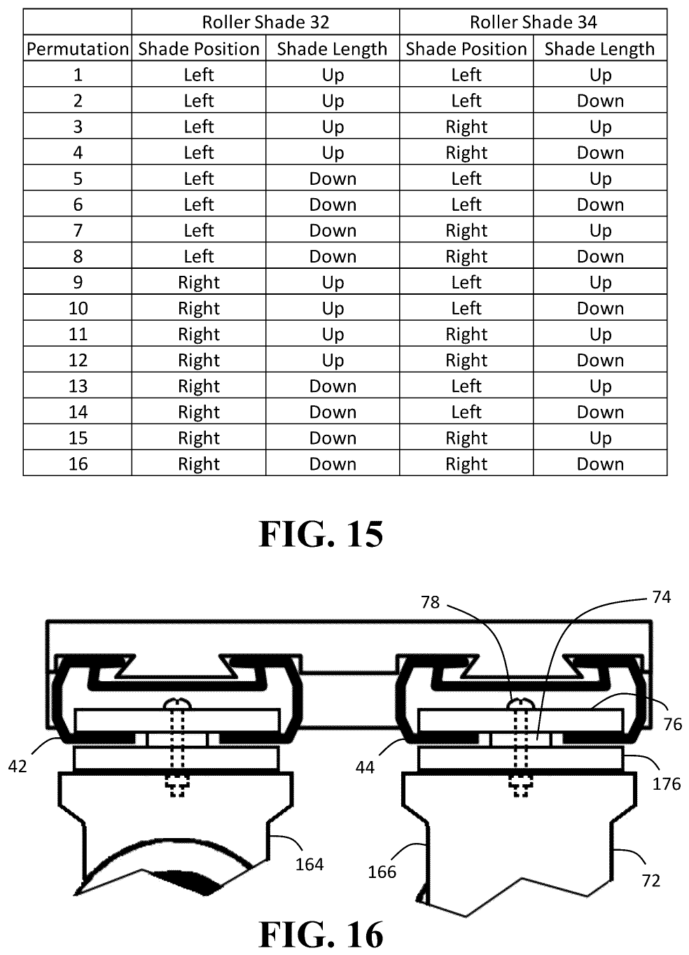

As discussed above, each shade 62 can be retracted and extended between fully raised and fully lowered positions, and the roller shades 32, 34 can be independently translated left and right into fully overlapped and minimally overlapped positions relative to each other, and this can be done independently of the lengthwise extension or retraction of the shades 62. As a result, the pair of roller shades can be arranged into 16 different configurations of the fully overlapped, minimally overlapped, fully raised, and fully lowered positions. Those 16 permutations are listed in the table of FIG. 15, demonstrating the flexibility of different shade configurations available from the two roller shades 32, 34 of the roller shade system 30.

As mentioned, window covering systems are typically shipped partially disassembled. For example, the roller shade system 30 may advantageously be packaged with the tube assembly 71 being at least partially assembled—e.g., with the shade 62 attached to and rolled onto the tube 60 and the length adjuster 68 and end cap 70 already securely mounted in the ends of the tube (although any or all of these tube assembly components may be packaged disassembled). The roller brackets 64, 66 may or may not be pre-assembled to the tube assembly 71. The remaining components may be package disassembled, including the roller brackets 64, 66 (if not pre-assembled), tracks 42, 44, connecting brackets 46, 48, 50, bar 86 (if used), and any additional hardware and fasteners.

When packaged partially or wholly disassembled, the roller shade system 30 can be installed by the consumer or a professional as follows. As initial steps, roller shades 32, 34 and track assembly 36 are put together. For the roller shades, this may include assembling together all of the components shown in FIG. 5, or merely some of them if portions come pre-assembled. For the track assembly 36, the center bracket(s) 50, if included, can be slid onto the T-slot rail 88 of each track 42, 44 using their T-nuts 92, 94. One of the end brackets 46, 48 can then be installed at its associated first or second end of the two tracks. If the second end bracket can be left unattached until after wall mounting the track assembly (e.g., where there is no obstruction to inserting the roller shades into its end of the tracks), then the center bracket(s) and first end bracket may then be secured to the wall above the building opening. The roller shades 32, 34 are then inserted into the still open end of the respective tracks 42, 44, observing to insert the roller shades such that they roll and unroll their shades in the space between them to obtain the inside reverse rotation direction. Thereafter, the second end bracket may be attached to the tracks and to the wall. Where both end brackets must be attached prior to mounting on the wall, soffit, ceiling, etc., the two roller shades can instead assembled into their tracks, the second end bracket then attached to the tracks, and the entire roller shade assembly 30 then mounted over the building opening.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A translatable roller shade system for mounting over a building opening, the roller shade system comprising:
elongated first and second tracks that, when mounted, are positioned adjacent each other such that they extend horizontally in parallel from a first end of the roller shade system to a second end of the roller shade system, the tracks each having a channel that, when mounted, has a downward-facing slot extending along at least a substantial portion of the track between the first and second ends of the roller shade system; and
first and second roller shades each comprising a tube, a shade wrapped on the tube, first and second roller brackets that support the tube at each end of the tube, and a length adjuster that connects between the tube and at least one roller bracket to enable adjustment of the roller shade between a lowered position in which the shade is lowered over the building opening and a raised position in which the shade is rolled up onto the tube so as to reveal the building opening;
wherein the first and second roller shades, when installed, are supported from above by the respective first and second tracks for translational movement relative to the tracks and each other such that the roller shades can be moved left or right along the tracks between fully overlapped and minimally overlapped positions.

2. The translatable roller shade system of claim 1, wherein the roller shades, when installed, have an inside reverse roll direction relative to each other.

3. The translatable roller shade system of claim 1, wherein the first and second roller shades, when installed, are spaced from each other by an offset distance that is within the range of 3 to 5 inches.

4. The translatable roller shade system of claim 1, wherein the first and second tracks each comprise sections of aluminum track, and wherein the roller shade system further comprises a plurality of connecting brackets that attach to each track to rigidly fix the tracks together into a parallel orientation.

5. The translatable roller shade system of claim 4, wherein the connecting brackets are configured to attach to the tracks so as to maintain the tracks in a spaced, parallel orientation relative to each other.

6. The translatable roller shade system of claim 4, wherein the connecting brackets include a pair of end brackets, wherein one of the end brackets attaches to a first end of each track and the other of the end brackets attaches to a second end of each track.

7. The translatable roller shade system of claim 6, wherein each of the tracks include an external T-slot rail extending between the first and second ends of the track opposite the slot, and wherein each end bracket includes a pair of T-nuts that fit into mating engagement with the T-slot rail at the ends of the tracks.

8. The translatable roller shade system of claim 7, wherein the end brackets each comprise an upper plate having the T-nuts located on a lower side of the upper plate and a side plate extending downwardly from the upper plate adjacent the T-nuts, wherein the side plate comprises an abutment against which one end of each of the tracks bear when the end bracket is attached to that end of the tracks by having the T-nuts fully inserted into the T-slot rails at that one end.

9. The translatable roller shade system of claim 8, wherein each of the end brackets comprise an identical unitary piece of milled aluminum and the each of the tracks comprise identical sections of extruded aluminum.

10. The translatable roller shade system of claim 7, wherein the plurality of connecting brackets include at least one center bracket having a pair of integral T-nuts on a lower side of the center bracket, the T-nuts adapted to fit into mating engagement with the T-slot rails.

11. The translatable roller shade system of claim 1, wherein the roller brackets each include a bracket body and a glide member, wherein the glide members each fit into the channel of an associated one of the tracks from an end of the track, the glide member of each roller bracket being attached to the bracket body via a connecting link that, when mounted, extends from the glide member through the slot to the bracket body, wherein the glide member is larger than the slot such that the glide member is captured for gliding movement along the track to thereby permit translational movement of the roller shades along the length of the track.

12. The translatable roller shade system of claim 11, wherein the glide member of each roller bracket comprises nylon or acetal plastic.

13. The translatable roller shade system of claim 1, wherein the building opening comprises first and second glazed panels positioned side by side when the building opening is closed, the glazed panels each having a width and length, and wherein each shade has a width and fully lowered length that are the same or larger than the width and length of the glazed panels, respectively.

14. The translatable roller shade system of claim 1, wherein each shade can be retracted and extended between fully raised and fully lowered positions, wherein the roller shades can be independently translated left and right into fully overlapped and minimally overlapped positions relative to each other independently of the lengthwise extension or retraction of the shades, wherein the pair of roller shades can be arranged into 16 different configurations of the fully overlapped, minimally overlapped, fully raised, and fully lowered positions.

15. The translatable roller shade system of claim 1, wherein the roller shades each comprise a zero-gravity roller shade.

16. The translatable roller shade system of claim 1, wherein the length adjuster comprises a chain loop and a roller shade clutch.

17. The translatable roller shade system of claim 1, wherein the shade has a substantially uniform appearance throughout the length and width of the shade.

18. A roller shade system comprising:
a pair of roller shades each having a shade that can be retracted and extended between fully raised and fully lowered positions, wherein the roller shades can be independently translated left and right into fully overlapped and minimally overlapped positions relative to each other independently of the lengthwise extension or retraction of the shades, wherein the pair of roller shades can be arranged into 16 different configurations of the fully overlapped, minimally overlapped, fully raised, and fully lowered positions.

19. The roller shade system of claim 18, wherein the roller shades have opposite rotational directions such that the shade of each roller shade rolls and unrolls from a side of the roller shade closest to the other roller shade.

20. The translatable roller shade system of claim 18, wherein the shade has a substantially uniform appearance throughout the length and width of the shade.
